(19) United States
(12) Patent Application Publication
(10) Pub. No.: US 2017/0236699 A1
(43) Pub. Date: Aug. 17, 2017

(54) MASS SPECTROMETER

(71) Applicant: Shimadzu Corporation, Kyoto (JP)

(72) Inventors: Hiroko UEDA, Joyo-shi, Kyoto (JP); Takeshi UCHIDA, Kyoto-shi, Kyoto (JP)

(73) Assignee: Shimadzu Corporation, Kyoto (JP)

(21) Appl. No.: 15/502,533

(22) PCT Filed: Aug. 20, 2014
(86) PCT No.: PCT/JP2014/071717

§ 371 Date: Feb. 8, 2017

(51) Int. Cl. H01J 49/16; H01J 49/02

(52) U.S. Cl. CPC H01J 49/165; H01J 49/025

(57) ABSTRACT

Before a sample is pierced with a probe of a PESI ion source, a total ion current is measured under a condition with no voltage applied from a high voltage generator to the probe as well as under a condition with the voltage applied. If the probe is properly attached to the holder, a considerable difference in total ion current occurs between the period with no voltage applied and the period with the voltage applied. By comparison, if the probe is improperly attached, no significant difference in the total ion current occurs between the period with no voltage applied and the period with the voltage applied. Referring to a threshold determined under the normal condition, a probe attachment checker detects an insufficient attachment of the probe by checking the difference in the total ion current, and displays an error message on a display unit if an improper attachment is detected.

### TECHNICAL FIELD

The present invention relates to a mass spectrometer, and more specifically to a mass spectrometer having an ion source using a probe electrospray ionization method.

### BACKGROUND ART

In recent years, for the diagnosis of cancers or similar purposes, mass spectrometers capable of a real-time measurement of specific substances (tumor markers) contained in biological tissues have been actively developed.

Patent Literature 1 and Non Patent Literature 1 disclose a cancer diagnosis assistance system using a mass spectrometer having an ion source using a probe electrospray ionization (PESI) method, which is one type of atmospheric ionization method.

The PESI method is a comparatively new ionization method. A PESI ion source includes an electrically conductive probe, a displacement section for driving at least either the probe or sample so as to make the sample adhere to the tip of the probe, and a high voltage generator for applying a high voltage to the probe with the sample adhered to the tip of the probe. In a measurement, at least either the probe or sample is driven by the displacement section so as to make the tip of the probe come in contact with or slightly pierce the sample, making the sample adhere to the tip surface of the probe. Subsequently, the probe is removed from the sample by the displacement section, and a high voltage is applied from the high voltage generator to the probe. Then, a strong electric field acts on the sample adhered to the tip of the probe, causing the electrospray phenomenon, whereby the sample molecules are ionized while being detached.

In general, the ionization using the electrospray phenomenon provides a higher level of ionizing efficiency than the other techniques, such as the ionization by laser light irradiation. Therefore, the PESI ion source can efficiently ionize the molecules in a trace amount of sample. Additionally, for example, this device can directly ionize an extremely small amount of biological tissue sampled from a subject, without requiring any pretreatment (including the dissolution, dispersion, etc.) to be performed on the sample. Furthermore, the device can sequentially perform the ionization for a plurality of sites within a one-dimensional or two-dimensional area on the sample by changing the position on the sample at which the sample is pierced with the probe. Such an operation advantageously enables a distribution analysis on a one-dimensional or two-dimensional area.

In the previously described type of PESI ion source, every time a measurement of one sample (or one point on one sample) is performed, the sample adheres to the tip of the probe. Therefore, in order to avoid contamination, it is necessary to replace the probe with a new one or clean the tip of the probe for every measurement. The latter requires a complex system and yet does not guarantee that the contamination can be completely prevented by the cleaning. Accordingly, probes are normally handled as disposables and should be replaced for every measurement.

For easy replacement of the probe, conventional PESI ion sources are configured so that the probe (e.g. a metallic acupuncture needle with a tip diameter of several hundred nanometers) is fixed by having its base portion inserted into a hole formed in a holder. The attachment and removal of the needle to and from this holder is performed by an operator using tweezers (or similar tools). Since the needle is extremely thin and small, it is possible that the needle is insufficiently inserted into the hole in the holder and eventually falls off the holder during the measurement. Another possible situation is that the operator carelessly initiates a measurement while omitting to attach a new probe after having removed the used one from the holder.

If the probe is improperly attached to the holder or detached from it, the measurement cannot yield a correct result, and the measurement time is wasted. Additionally, if the target of the measurement is a substance sampled from a living organism, the substance will undergo degradation or denaturation with the passage of time after the sampling. Therefore, if an unnecessary amount of time is consumed in the measurement due to the aforementioned factor, the sample may be no longer usable when the measurement is once more attempted from the beginning.

### CITATION LIST

### Patent Literature

Patent Literature 1: JP 2014-44110 A

### Non Patent Literature

Non Patent Literature 1: Sen Takeda and seven other authors, “Developing a Novel Cancer Diagnostic System Based on the Mass Spectrometry and Learning Machine”. Shimadzu Review, Vol. 69, Nos. 3 and 4. March 2013

### SUMMARY OF INVENTION

### Technical Problem

The present invention has been developed to solve the previously described problems. Its objective is to provide a mass spectrometer capable of preventing an insufficient attachment of the probe and an omission of the attachment of the probe.

### Solution to Problem

The present invention developed for solving the previously described problem is a mass spectrometer including: an electrically conductive probe; a holder for holding the probe; a high voltage generator for applying a high voltage to the probe; and a displacement section for driving at least either the probe or a sample so as to make the sample adhere to the tip of the probe, the mass spectrometer configured to ionize a component in the sample under atmospheric pressure using an electrospray phenomenon by making a portion of the sample adhere to the tip of the probe by means of the displacement section and applying a high voltage to the probe with the tip of the probe removed from the sample, and the mass spectrometer further including:

a) an analysis controller for controlling relevant sections so as to perform both a mass spectrometry without the high voltage applied to the probe and a mass spectrometry with the high voltage applied to the probe, under the condition that the probe, with no sample yet adhered to the tip of the probe, is out of contact with the sample; and

b) a probe attachment checker for determining the state of attachment of the probe to the holder, based on the difference or ratio between the result of the mass spectrometry without the high voltage applied to the probe and the result of the mass spectrometry with the high voltage applied to the probe performed under the control of the analysis controller.

That is to say, the mass spectrometer according to the present invention is equipped with an ion source using the PESI method disclosed in Patent Literature 1, Non Patent Literature 1 or other documents. This ion source may supplementarily be provided with a spraying section for spraying a solvent toward the tip of the probe.

In the mass spectrometer according to the present invention, when a high voltage is applied by the high voltage generator to the probe with no sample adhered to the tip of the probe, the components which exist in the air around the probe are ionized. Therefore, when the mass spectrometry with the high voltage applied to the probe is performed under the control of the analysis controller, a signal which reflects the amount of ions originating from those components in the air is obtained. By comparison, when the high voltage is not applied to the probe, no ionization occurs. Accordingly, the signal obtained in the mass spectrometry without the high voltage applied to the probe mainly reflects the noise originating from the measurement system. Therefore, if the probe is properly attached to the holder and the high voltage can be correctly applied to the probe, a considerable difference occurs between the signal which is the result of the mass spectrometry without the high voltage applied to the probe and the signal which is the result of the mass spectrometry with the high voltage applied to the probe.

By comparison, if the probe is improperly attached to the holder or completely detached from the holder, the ionization of the components in the air does not effectively occur when the high voltage is generated in the high voltage generator in order to apply the high voltage to the probe. Therefore, almost no difference occurs between the signal which is the result of the mass spectrometry without the high voltage applied to the probe and the signal which is the result of the mass spectrometry with the high voltage applied to the probe. Accordingly, for example, the probe attachment checker determines whether or not the probe is properly attached, by comparing, with a previously set threshold, the difference or ratio between the result of the mass spectrometry without the high voltage applied to the probe and the result of the mass spectrometry with the high voltage applied to the probe.

If an improper attachment of the probe to the holder is detected before the initiation of the mass spectrometry for the target sample, it is necessary to inform a user (operator) of the fact as quickly as possible and urge the user to reattach the probe. Accordingly, the mass spectrometer according to the present invention should preferably further include an alerting section for issuing an alert for an operator if it is determined by the probe attachment checker that the probe is improperly attached to the holder.

For example, the alerting section may be configured to display an error message on a display screen or produce a warning tone. According to this configuration, if the probe is improperly attached or completely detached from the holder, the operator can promptly ascertain the situation and take appropriate measures, such as discontinuing the analysis and reattaching the probe. Consequently, an unnecessary depletion of the measurement time can be avoided, and furthermore, degradation or denaturation of biological samples can also be prevented.

The aforementioned threshold used for determining whether or not the probe is properly attached can be previously determined based on the result of a mass spectrometry without the high voltage applied to the probe and the result of a mass spectrometry with the high voltage applied to the probe, under the condition that the probe is properly attached. Since the result of the mass spectrometry involves a certain amount of individual difference among devices, the function of determining and storing the threshold based on the actual measurements with the properly attached probe should preferably be provided in each individual device.

That is to say, in a preferable mode of the mass spectrometer according to the present invention.

the mass spectrometer further includes a threshold-obtaining section for calculating and saving a threshold for determining the state of attachment, based on the difference or ratio between the result of the mass spectrometry without the high voltage applied to the probe and the result of the mass spectrometry with the high voltage applied to the probe, performed under the control of the analysis controller, with the probe properly attached to the holder, and

the probe attachment checker is configured to determine the state of attachment of the probe to the holder by comparing, with the threshold saved by the threshold-obtaining section, the difference or ratio between the result of the mass spectrometry without the high voltage applied to the probe and the result of the mass spectrometry with the high voltage applied to the probe, performed under the control of the analysis controller.

It is not necessary to frequently perform the task of saving of the threshold by the threshold-obtaining section. Normally, the task only needs to be performed when the device is installed or maintained (e.g. repaired). Accordingly, for example, the device can be configured so that an individual in charge of the maintenance of the device or a service representative of the device manufacturer can perform the threshold-saving operation using the threshold-obtaining section by following an operation procedure different from the normal analysis.

In the mass spectrometer according to the present invention, a total ion current signal over a predetermined mass-to-charge-ratio range can preferably be used as the result of the mass spectrometry. This enables a reliable determination of the state of attachment of the probe to the holder even if the mass-to-charge ratio of the ion which is mainly generated when the high voltage is applied with no sample adhered to the tip of the probe is unknown.

As one mode of the mass spectrometer according to the present invention:

the analysis controller may preferably be configured to perform a control of the relevant sections so as to perform both the mass spectrometry without the high voltage applied to the probe and the mass spectrometry with the high voltage applied to the probe in advance of a mass spectrometry for a target sample, and to subsequently execute the mass spectrometry for the target sample if it is determined by the probe attachment checker under the aforementioned control that the probe is properly attached to the holder.

In other words, according to this configuration, the determination on the state of attachment of the probe to the holder is automatically performed immediately before a mass spectrometry for a target sample is performed. The device can promptly inform the operator of the situation that the probe is improperly attached and will unfavorably affect the analysis. This device can also assuredly prevent the mass spectrometry for the target sample from being executed despite an improper attachment of the probe.

### Advantageous Effects of the Invention

In the mass spectrometer according to the present invention, if the probe is attached in an improper form that is difficult to detect through the visual check by an operator, or if the operator forgets to attach a new probe, the mass spectrometer can automatically detect the situation and take appropriate measures, such as alerting the user or discontinuing the operation before the analysis for the target sample is performed. As a result, the measurement is prevented from being performed using an improperly attached probe and leading to a waste of measurement time or a waste of a sample due to the degradation of the sample with the passage of time. Another advantage of the mass spectrometer according to the present invention exists in that the electrical determination of the precision of the attachment of the probe reduces the workload on the operator in checking the state of attachment of the probe.

### BRIEF DESCRIPTION OF DRAWINGS

FIG. 1 is a schematic configuration diagram of a mass spectrometer using a PESI ion source according to one embodiment of the present invention.

FIG. 2 is a flowchart of the process for obtaining a threshold used for the probe attachment check in the mass spectrometer of the present embodiment.

FIG. 3 is a flowchart of the probe attachment checking process in the mass spectrometer of the present embodiment.

FIGS. 4A and 4B show a measured example of the total ion chromatogram obtained under the condition that the probe is properly attached and one obtained under the condition that no probe is attached in the mass spectrometer of the present embodiment.

### DESCRIPTION OF EMBODIMENTS

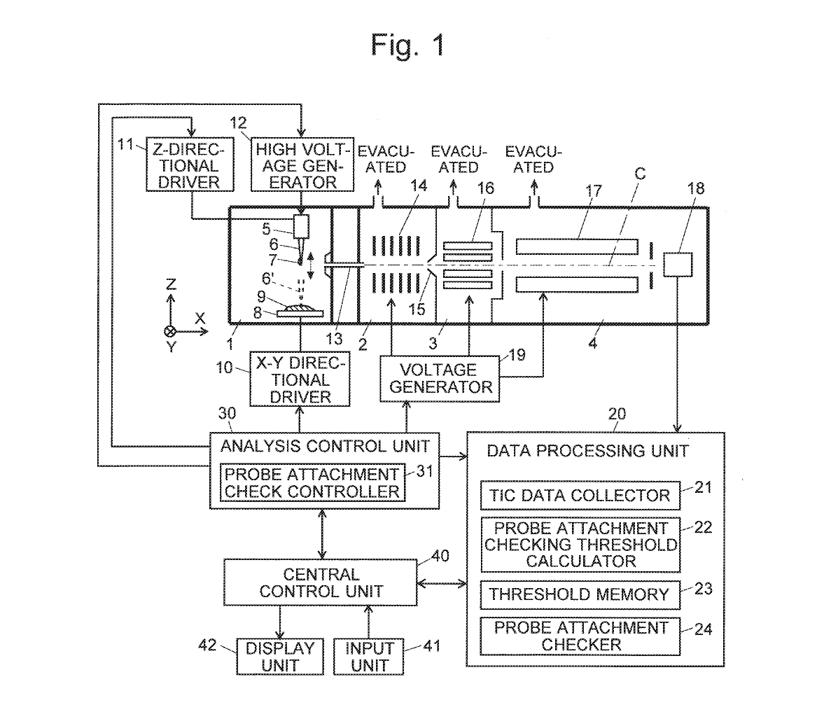

One embodiment of the mass spectrometer according to the present invention is described with reference to the attached drawings. FIG. 1 is a schematic configuration diagram of a mass spectrometer using a PESI ion source according to the present embodiment.

The mass spectrometer of the present embodiment has the configuration of a differential pumping system including an ionization chamber 1 for ionizing components in a sample under atmospheric pressure and an analysis chamber 4 for performing the mass separation and detection of ions under a high degree of vacuum, between which a plurality of (in the present example, two) intermediate vacuum chambers 2 and 3 are provided having their degrees of vacuum increased in a stepwise manner. Although not shown in FIG. 1, normally, the first intermediate vacuum chamber 2 is evacuated with a rotary pump, while the second intermediate vacuum chamber 3 and the analysis chamber 4 are evacuated with a turbo molecular pump in addition to the rotary pump.

The ionization chamber 1 maintained at substantially atmospheric pressure contains a sample stage 8 for holding a sample 9, with a metallic probe 6 held in a holder 5 located in the space above the sample stage 8. The holder 5 has a holding hole bored in it. By pushing the base portion of the probe 6 into this hole, the probe 6 is held in the holder 5. The probe 6 held in the holder 5 can be driven in the Z-axis direction in the figure by a Z-directional driver 11 including a motor and speed reduction mechanism, or an actuator or similar elements. The holder 5 can also be manually driven in at least the X-axis or Y-axis direction so that such tasks as the replacement of the probe 6 (which will be described later) can be smoothly performed. A maximum of several kilovolts of high voltage can be applied from a high voltage generator 12 to the probe 6. The sample stage 8 can be driven in both X-axis and Y-axis directions in the figure by an X-Y directional driver 10 including a motor, speed reduction mechanism and other elements. By this mechanism, the position at which the tip of the probe comes in contact with the surface of the sample 9 when the probe 6 is lowered can be arbitrarily changed in the X-Y plane.

Additionally, a nozzle for spraying a predetermined kind of solvent, such as water, alcohol or acetonitrile, in the form of fine droplets toward an area near the tip of the probe 6 to assist ionization as described in Patent Literature 1 (or other documents) may be provided, although such a nozzle is not provided in the present embodiment.

The ionization chamber 1 communicates with the first intermediate vacuum chamber through a thin desolvation tube 13. Due to a pressure difference between the two open ends of the desolvation tube 13, the gas in the ionization chamber 1 is drawn through the desolvation tube 13 into the first intermediate vacuum chamber 2. The first intermediate vacuum chamber contains a first ion guide 14, which may be called the “Q array”, having four virtual rod electrodes arranged around the ion beam axis C, with each virtual rod electrode formed by a plurality of disc-shaped plate electrodes arranged along the ion beam axis C. The first intermediate vacuum chamber 2 communicates with the second intermediate vacuum chamber through an orifice having a small diameter formed at the apex of a skimmer 15. The second intermediate vacuum chamber 3 contains a second ion guide 16 having an octapole structure with eight rod electrodes arranged around the ion beam axis C. The analysis chamber 4 as the last stage contains a quadrupole mass filter 17 having four rod electrodes arranged around the ion beam axis C and an ion detector 18 which produces signals corresponding to the number (amount) of ions it receives. A voltage generator 19 applies predetermined amounts of voltage to the first ion guide 14, second ion guide 16 and quadrupole mass filter 17, as well as the desolvation tube 13, ion detector 18 and other relevant elements, although the signals lines for the latter group of elements are omitted from the figure.

An analysis control unit 30 controls the X-Y directional driver 10, Z-directional driver 11, high voltage generator 12, voltage generator 19 and other devices in order to perform a mass spectrometry for a small amount of specimen taken from the sample 9. The analysis control unit 30 includes a probe attachment check controller 31 as its characteristic functional block. The detection signals produced by the ion detector 18 are sent to a data processing unit 20, which converts those signals into digital data and performs predetermined data processing operations. The data processing unit 20 includes, as its characteristic functional blocks, a TIC (total ion current) data collector 21, probe attachment checking threshold calculator 22, threshold memory 23, and probe attachment checker 24. A central control unit 40, to which an input unit 41 and display unit 42 are connected, is responsible for providing a user interface through these units as well as performing a system control at a higher level than the analysis control unit 30.

In general, the analysis control unit 30, central control unit 40 and data processing unit can be configured using a personal computer as a hardware resource, with their respective functions realized by running, on the personal computer, a dedicated controlling and processing software program preinstalled on the same computer.

Initially, a mass spectrometric operation performed by the mass spectrometer of the present invention for obtaining mass spectrum data for a target sample is described. For example, the sample 9 handled in this analysis is a portion of a biological tissue which has been sampled from a subject and is suspected of being a type of cancer.

As shown in FIG. 1, after the probe 6 is set at the ionization position (which is the position on the X-Y plane at which the ions generated from the probe 6 can be satisfactorily drawn into the desolvation tube 13) and the sample 9 is placed on the sample stage 8, the Z-directional driver 11 under the control of the analysis control unit 30 lowers the probe 6 to the level at which its tip slightly pierces the sample 9 (as indicated by the broken line 6′ in FIG. 1), and subsequently elevates the probe 6 to the predetermined level (as indicated by the solid line in FIG. 1). By this operation, a portion of the sample 9 is adhered to the tip of the probe 6. For convenience of explanation, the sample on the sample stage 8 is denoted by numeral 9, while the one adhered to the probe 6 is denoted by numeral 7. By appropriately driving the sample stage 8 using the X-Y directional driver 10, the portion of the sample 9 picked by the probe 6 as the sample 7 can be arbitrarily changed.

After that, the high voltage generator 12 applies a predetermined amount of high voltage to the probe 6. The polarity of the high voltage to be applied to the probe 6 depends on the polarity of the ions to be generated. When the high voltage is applied to the tip of the probe 6, a strong electric field acts on the inner portion of the sample 7 caught at the tip of the probe 6, inducing the Coulomb repulsion or similar force which causes the components in the sample 7 to be detached having an amount of imbalanced electric charges (i.e. electro-sprayed). During this process, the components in the sample 7 are ionized. The thereby produced ions are carried into the desolvation tube 13 by the stream of gas resulting from the aforementioned pressure difference, to be sent into the first intermediate vacuum chamber 2.

The ions derived from the sample 7 and sent into the first intermediate vacuum chamber 2 are transported and converged by the radio-frequency electric field created by the first ion guide 14, to be sent through the orifice at the apex of the skimmer 15 into the second intermediate vacuum chamber 3. Those ions are further converged by the radio-frequency electric field created by the second ion guide 16 and sent into the analysis chamber 4. The quadrupole mass filter 17, to which a voltage composed of a radio-frequency voltage superposed on a direct-current voltage is applied from the voltage generator 19, allows only an ion having a mass-to-charge ratio m/z corresponding to the applied voltage to pass through the space extending along the longitudinal axis of the quadrupole mass filter 17, while making the other ions with different mass-to-charge ratios diverge halfway. The voltage applied from the voltage generator 19 to the quadrupole mass filter 17 is continuously changed to scan a predetermined range. With this scan, the mass-to-charge ratio at which the ion is allowed to pass through the quadrupole mass filter 17 also continuously changes over a predetermined range. Accordingly, by measuring the intensity of the ions arriving at the ion detector 18 with the passage of time during one scan of the voltage, ion intensity information within a predetermined mass-to-charge-ratio range, i.e. mass spectrum information, can be obtained.

In the mass spectrometer of the present embodiment, the probe 6 is handled as a disposable item and needs to be replaced for every single measurement. There is no problem if this probe 6 is properly attached to the holder 5. On the other hand, if the probe is insufficiently inserted into the holding hole of the holder 5, the high voltage may not be applied to the probe 6, or the probe 6 may fall off during the measurement. The operator could also forget to attach a new probe 6 after removing the used probe 6.

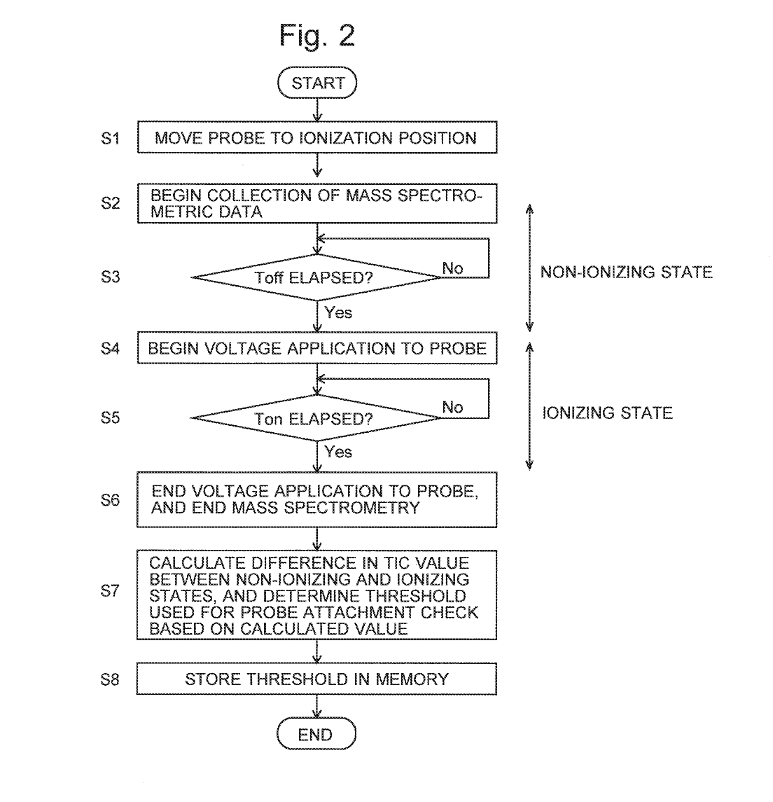

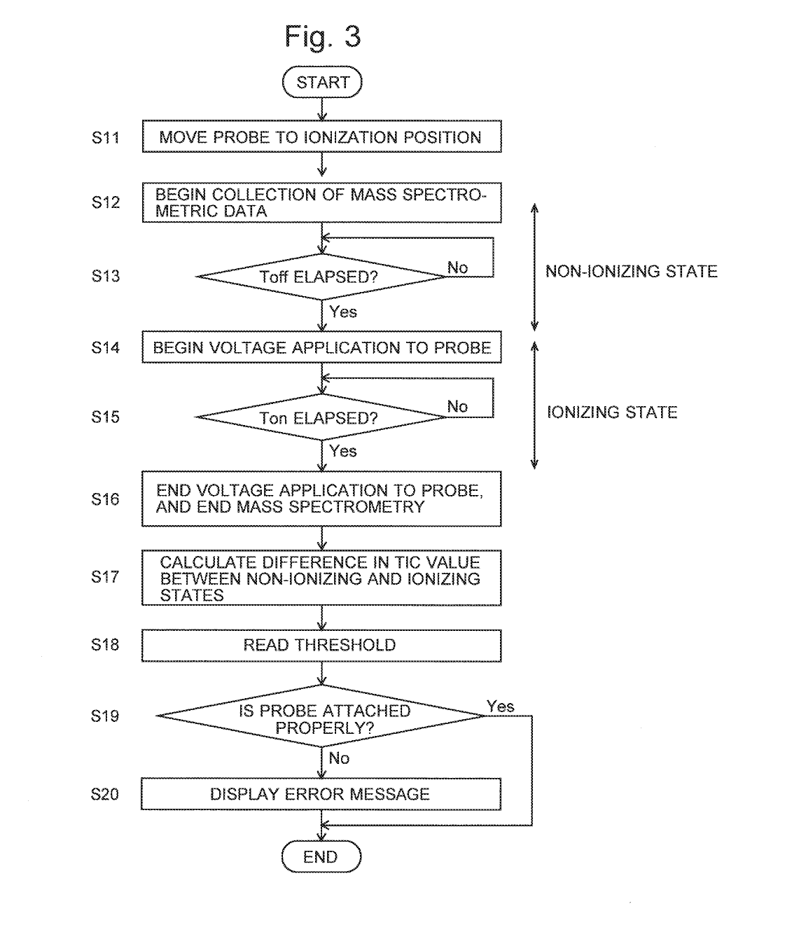

Accordingly, whether or not the probe 6 is properly attached to the holder 5 is automatically checked according to the following procedure. The process is hereinafter described with reference to FIGS. 2 and 3. FIG. 2 is a flowchart of the process for obtaining a threshold used for the probe attachment check. FIG. 3 is a flowchart of the probe attachment checking process.

To perform the probe attachment check in the mass spectrometer of the present embodiment, a threshold used for the check needs to be previously determined and stored in the threshold memory 23. For this purpose, at an appropriate point in time before the measurement for the target sample, a process for obtaining the threshold used for the probe attachment check is performed, with the probe 6 properly attached to the holder 5. Normally, this process does not need to be frequently performed; for example, it can be performed at the time of device installation or in a periodic inspection. It should be noted that no sample 9 is placed on the sample stage 8 in this process.

At the beginning of the process for obtaining the threshold used for the probe attachment check, if the probe 6 is not located at the ionization position, the operator should manually move the probe 6 to the ionization position (Step S1).

After that, under the control of the probe attachment check controller 31, the process of collecting mass spectrometric data is performed, with the high voltage generator 12 generating no high voltage which is used in the normal ionization process (Step S2). Since no voltage is applied to the probe 6, no ionization occurs within the ionization chamber 1, and accordingly, no ion is supplied to the desolvation tube 13 and subsequent analyzing sections. In this state, the quadrupole mass filter 17 is controlled so as to repeatedly scan the predetermined mass-to-charge-ratio range. The TIC data collector 21 in the data processing unit 20 sequentially collects TIC signals over that mass-to-charge-ratio range with the passage of time. This state is maintained until a predetermined period of time Toff elapses from the beginning of the collection of the mass spectrometric data (“Yes” in Step S3). Since no effective ionization takes place during this predetermined period of time “Toff”, the state during this period is hereinafter called the “non-ionizing state”.

When the predetermined period of time Toff has elapsed since the beginning of the data collection, the high voltage generator 12 begins to apply a high voltage to the probe 6 (Step S4). Although no sample 7 is adhered to the tip of the probe 6 at this point, the components in the air around the tip of the probe 6 are ionized due to the effect of the electric field concentrated on the tip. Those ions are supplied to the desolvation tube 13 and subsequent analyzing sections. Accordingly, the TIC signals obtained after the beginning of the application of the high voltage reflect the amount of ions originating from the components in the air. This state is maintained until a predetermined period of time “Ton” is elapsed from the beginning of the application of the high voltage (“Yes” in Step S5). Since an ionization takes place during this predetermined period of time Ton, the state during this period is hereinafter called the “ionizing state”.

When the predetermined period of time Ton has elapsed since the beginning of the application of the high voltage, both the voltage application to the probe 6 and the collection of the mass spectrometric data are discontinued (Step S6).

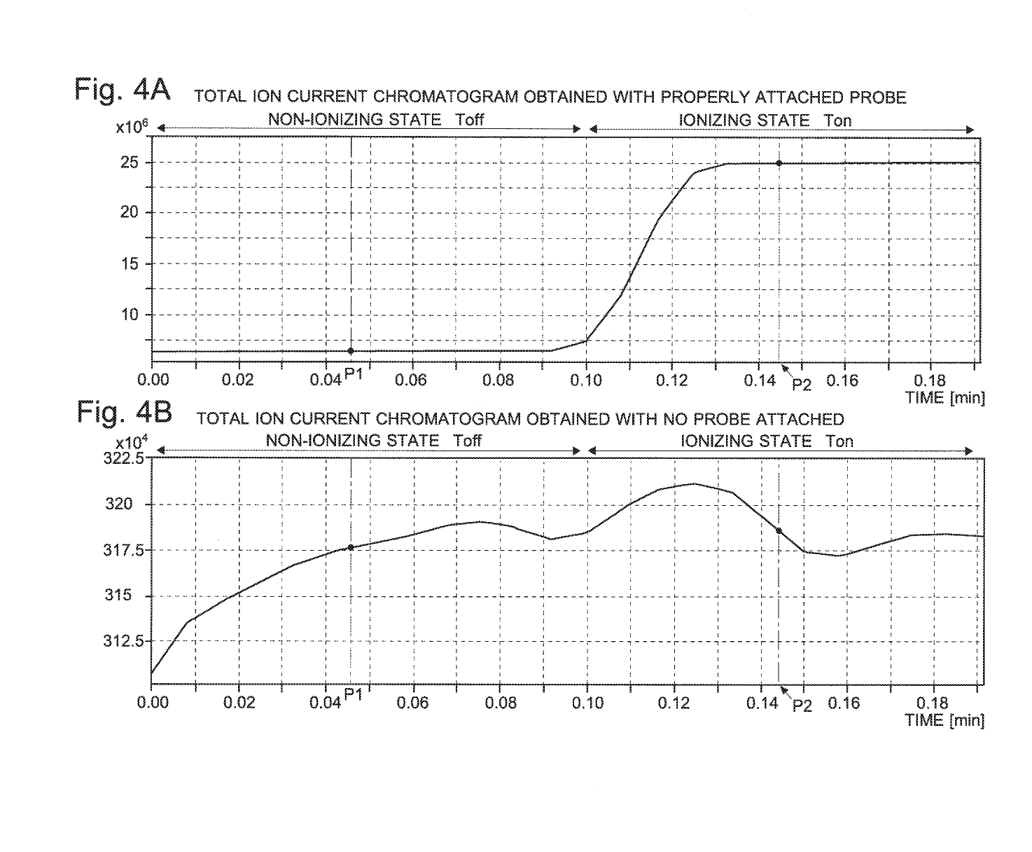

As one example, a total ion current chromatogram (total ion chromatogram) showing the temporal change in the TIC signal obtained in Steps S2 through S6 is shown in FIG. 4A. In this example, both Toff and Ton were set at six seconds. The voltage applied to the probe 6 was set at 2.76 kV. This voltage value was obtained by a fine tuning based on a voltage value which had been set by a normal automatic tuning function of the device. With this value, a sufficient amount of ions can be produced under the condition that the probe 6 is properly attached. FIG. 4A demonstrates that the signal intensity (TIC value) noticeably changes after the transition from the non-ionizing state to the ionizing state.

Subsequently, the probe attachment checking threshold calculator 22 computes the difference between the TIC value obtained in the non-ionizing state and the one obtained in the ionizing state. This difference in the TIC value can be expressed as IS-NJ, where N (noise) is the TIC value at a specific point in time in the non-ionizing state, while S (signal) is the TIC value at a specific point in time in the ionizing state. For example, N can be the TIC value at the point in time where a period of time Toff/2 has elapsed since the beginning of the data collection (P1 in FIG. 4A), and S can be the TIC value the point in time where a period of time Toff+(Ton/2) has elapsed since the beginning of the data collection (P2 in FIG. 4A). In the example of FIG. 4A, since N=6.5×10⁶ and S=25.0×10⁶, the difference in the TIC value |S−N| is approximately 18.5×10⁶.

It should be noted that the definition of S and N is not limited to this example. For instance, the largest value of the TIC value in the non-ionizing state (within the Toff period) may be chosen as N, while the largest value of the TIC value in the ionizing state (within the Ton period) may be chosen as S. It is also possible to calculate the average (or similar value) of the TIC values within a predetermined period of time in each of the non-ionizing and ionizing states and use the obtained values as N and S, respectively.

The |S−N| value calculated in the previously described manner is the TIC-value difference to be observed under the ideal condition that the probe 6 is properly attached to the holder 5. Accordingly, based on this value, a threshold allowing for an appropriate amount of margin is determined (Step S7). For example, the threshold may be defined as 50% of the calculated value of |S−N|. The threshold determined in this manner is stored in the threshold memory 23 (Step S8).

Next, the probe attachment checking process which is performed before the execution of the measurement for the target sample is described using FIG. 3. For example, after the sample 9 as the measurement target is placed on the sample stage 8, when the operator issues a command to initiate the measurement on the input unit 41, the probe attachment check controller 31 in the analysis control unit 30 performs a control for the probe attachment checking process in advance of the actual measurement.

In FIG. 3. Steps 11 through S16 are essentially identical to Steps S1 through S6 in FIG. 2, and therefore, descriptions concerning those steps will be omitted. In the present situation, although the sample 9 is placed on the sample stage 8, the tip of the probe 6 is not in contact with the sample 9, and no sample 7 is adhered to the tip of the probe 6.

As a result of Steps S12 through S16, similarly to Steps S1 through S6, a total ion current chromatogram (total ion chromatogram) showing a temporal change in the TIC signal is obtained. Subsequently, the probe attachment checker 24 calculates the difference between the TIC value obtained in the non-ionizing state and the one obtained in the ionizing state. The method for calculating the difference in the TIC value is the same as used for determining the threshold, and yields the value of |S−N| (Step S17). If the probe 6 is properly attached to the holder 5, a total ion current chromatogram having a considerable difference in the TIC value between the non-ionizing and ionizing states as in the previous case of determining the threshold, i.e. as shown in FIG. 4A, should be obtained. By comparison, if the probe 6 is improperly attached to the holder 5, no ionization of the components in the air around the tip of the probe 6 occurs even in the Ton period, and the state is practically unchanged from the non-ionizing state. Consequently, no significant difference between the TIC value in the Toff period and the one in the Ton period occurs in the total ion current chromatogram.

As one example, a total ion current chromatogram (total ion chromatogram) showing the temporal change in the TIC signal obtained by performing the process of Steps S12 through S16 with no probe 6 attached to the holder 5 is shown in FIG. 4B. Toff, Ton and the value of the voltage applied to the probe 6 are the same as in FIG. 4A. FIG. 4B evidently demonstrates that there is no significant difference in the signal intensity (TIC value) between the non-ionizing and ionizing states. In the example of FIG. 4B, in which N=3.18×10⁶ and S=3.17×10⁶, the calculation of |S−N| yields a value of approximately 0.01×10⁶. This result confirms that there is a noticeable difference from the value of |S−N| obtained with the properly attached probe 6, and therefore, it is possible to precisely determine whether or not the probe 6 is properly attached based on the threshold determined in the previously described manner.

Accordingly, the probe attachment checker 24 reads the threshold from the threshold memory 23 (Step S18), and compares the difference in the TIC value calculated in Step S17 with that threshold, to determine whether or not the TIC value is equal to or greater than the threshold and thereby determine whether or not the probe 6 is properly attached to the holder (Step S19). If the TIC-value difference is equal to or greater than the threshold, it is possible to infer that the probe 6 is properly attached to the holder 5. Accordingly, the checking process is discontinued and the measurement for the sample 9 placed on the sample stage 8 is subsequently performed.

By comparison, if the TIC-value difference is determined to be less than the threshold in Step S19, it is most likely that the probe 6 is improperly attached to the holder 5. Accordingly, the probe attachment checker 24 displays, via the central control unit 40, an error message informing of an insufficient attachment of the probe on the display screen of the display unit 42 (Step S20). A warning tone may also be produced along with the display output. When the error message is displayed, the operation may be halted before the execution of the measurement of the sample 9, or the measurement may be executed after the error message is displayed. In any case, the error massage allows the operator to recognize the possibly insufficient attachment of the probe 6 and promptly take appropriate measures, such as discontinuing the measurement and performing a visual check.

In the previous embodiment, the sum of the amounts of ions sampled by the mass spectrometer over the entire range of mass-to-charge ratios (in practice, a wide predetermined range of mass-to-charge ratios), i.e. the TIC value, is used for the calculation of |S−N|. In the case where the ions are noticeably detected within a narrow specific range of mass-to-charge ratios or at a specific mass-to-charge ratio due to such factors as the influence of the installation site of the device, an EIC (extracted ion chromatogram) which shows the temporal change in the amount of ions within a limited range of mass-to-charge ratios may be used to calculate |S−N|. The ratio of the TIC value (S/N) may also be used in place of the difference in the TIC value, |S−N|.

The previous embodiment is one example of the present invention, and any change, modification or addition appropriately made within the spirit of the present invention will evidently fall within the scope of claims of the present application.

### REFERENCE SIGNS LIST

1 . . . Ionization Chamber
2 . . . First Intermediate Vacuum Chamber
3 . . . Second Intermediate Vacuum Chamber
4 . . . Analysis Chamber
5 . . . Holder
6 . . . Probe
7, 9 . . . Sample
8 . . . Sample Stage
10 . . . Y-Directional Driver
11 . . . Z-Directional Driver
12 . . . High Voltage Generator
13 . . . Desolvation Tube
14 . . . First Ion Guide
15 . . . Skimmer
16 . . . Second Ion Guide
17 . . . Quadrupole Mass Filter
18 . . . Ion Detector
19 . . . Voltage Generator
20 . . . Data Processing Unit
21 . . . TIC Data Collector
22 . . . Probe Attachment Checking Threshold Calculator
23 . . . Threshold Memory
24 . . . Probe Attachment Checker
30 . . . Analysis Control Unit
31 . . . Probe Attachment Check Controller
40 . . . Central Control Unit
41 . . . Input Unit
42 . . . Display Unit

1. A mass spectrometer including: an electrically conductive probe; a holder for holding the probe; a high voltage generator for applying a high voltage to the probe; and a displacement section for driving at least either the probe or a sample so as to make the sample adhere to a tip of the probe, the mass spectrometer configured to ionize a component in the sample under atmospheric pressure using an electrospray phenomenon by making the sample adhere to the tip of the probe by means of the displacement section and applying a high voltage to the probe with the tip of the probe removed from the sample, and the mass spectrometer comprising:
a) an analysis controller for controlling relevant sections so as to perform both a mass spectrometry without the high voltage applied to the probe and a mass spectrometry with the high voltage applied to the probe, under a condition that the probe, with no sample yet adhered to the tip of the probe, is out of contact with the sample; and
b) a probe attachment checker for determining a state of attachment of the probe to the holder, based on a difference or ratio between a result of the mass spectrometry without the high voltage applied to the probe and a result of the mass spectrometry with the high voltage applied to the probe performed under a control of the analysis controller.

2. The mass spectrometer according to claim 1, further comprising:
an alerting section for issuing an alert for an operator if it is determined by the probe attachment checker that the probe is improperly attached to the holder.

3. The mass spectrometer according to claim 1, further comprising:
a threshold-obtaining section for calculating and saving a threshold for determining the state of attachment, based on the difference or ratio between the result of the mass spectrometry without the high voltage applied to the probe and the result of the mass spectrometry with the high voltage applied to the probe, performed under the control of the analysis controller, with the probe properly attached to the holder,
wherein the probe attachment checker is configured to determine the state of attachment of the probe to the holder by comparing, with the threshold saved by the threshold-obtaining section, the difference or ratio between the result of the mass spectrometry without the high voltage applied to the probe and the result of the mass spectrometry with the high voltage applied to the probe, performed under the control of the analysis controller.

4. The mass spectrometer according to claim 1, wherein:
a total ion current signal over a predetermined mass-to-charge-ratio range is used as the result of the mass spectrometry.

5. The mass spectrometer according to claim 1, wherein:
the analysis controller performs a control of the relevant sections so as to perform both the mass spectrometry without the high voltage applied to the probe and the mass spectrometry with the high voltage applied to the probe in advance of a mass spectrometry for a target sample, and executes the mass spectrometry for the target sample if it is determined by the probe attachment checker under the aforementioned control that the probe is properly attached to the holder.

6. The mass spectrometer according to claim 2, further comprising:
a threshold-obtaining section for calculating and saving a threshold for determining the state of attachment, based on the difference or ratio between the result of the mass spectrometry without the high voltage applied to the probe and the result of the mass spectrometry with the high voltage applied to the probe, performed under the control of the analysis controller, with the probe properly attached to the holder,
wherein the probe attachment checker is configured to determine the state of attachment of the probe to the holder by comparing, with the threshold saved by the threshold-obtaining section, the difference or ratio between the result of the mass spectrometry without the high voltage applied to the probe and the result of the mass spectrometry with the high voltage applied to the probe, performed under the control of the analysis controller.

7. The mass spectrometer according to claim 2, wherein:
a total ion current signal over a predetermined mass-to-charge-ratio range is used as the result of the mass spectrometry.

8. The mass spectrometer according to claim 3, wherein:
a total ion current signal over a predetermined mass-to-charge-ratio range is used as the result of the mass spectrometry.

9. The mass spectrometer according to claim 6, wherein:
a total ion current signal over a predetermined mass-to-charge-ratio range is used as the result of the mass spectrometry.

10. The mass spectrometer according to claim 2, wherein:
the analysis controller performs a control of the relevant sections so as to perform both the mass spectrometry without the high voltage applied to the probe and the mass spectrometry with the high voltage applied to the probe in advance of a mass spectrometry for a target sample, and executes the mass spectrometry for the target sample if it is determined by the probe attachment checker under the aforementioned control that the probe is properly attached to the holder.

11. The mass spectrometer according to claim 3, wherein:
the analysis controller performs a control of the relevant sections so as to perform both the mass spectrometry without the high voltage applied to the probe and the mass spectrometry with the high voltage applied to the probe in advance of a mass spectrometry for a target sample, and executes the mass spectrometry for the target sample if it is determined by the probe attachment checker under the aforementioned control that the probe is properly attached to the holder.

12. The mass spectrometer according to claim 4, wherein:
the analysis controller performs a control of the relevant sections so as to perform both the mass spectrometry without the high voltage applied to the probe and the mass spectrometry with the high voltage applied to the probe in advance of a mass spectrometry for a target sample, and executes the mass spectrometry for the target sample if it is determined by the probe attachment checker under the aforementioned control that the probe is properly attached to the holder.

13. The mass spectrometer according to claim 6, wherein:
the analysis controller performs a control of the relevant sections so as to perform both the mass spectrometry without the high voltage applied to the probe and the mass spectrometry with the high voltage applied to the probe in advance of a mass spectrometry for a target sample, and executes the mass spectrometry for the target sample if it is determined by the probe attachment checker under the aforementioned control that the probe is properly attached to the holder.

14. The mass spectrometer according to claim 7, wherein:
the analysis controller performs a control of the relevant sections so as to perform both the mass spectrometry without the high voltage applied to the probe and the mass spectrometry with the high voltage applied to the probe in advance of a mass spectrometry for a target sample, and executes the mass spectrometry for the target sample if it is determined by the probe attachment checker under the aforementioned control that the probe is properly attached to the holder.

15. The mass spectrometer according to claim 8, wherein:
the analysis controller performs a control of the relevant sections so as to perform both the mass spectrometry without the high voltage applied to the probe and the mass spectrometry with the high voltage applied to the probe in advance of a mass spectrometry for a target sample, and executes the mass spectrometry for the target sample if it is determined by the probe attachment checker under the aforementioned control that the probe is properly attached to the holder.

16. The mass spectrometer according to claim 9, wherein:
the analysis controller performs a control of the relevant sections so as to perform both the mass spectrometry without the high voltage applied to the probe and the mass spectrometry with the high voltage applied to the probe in advance of a mass spectrometry for a target sample, and executes the mass spectrometry for the target sample if it is determined by the probe attachment checker under the aforementioned control that the probe is properly attached to the holder.
